(19) United States
(12) Patent Application Publication
(10) Pub. No.: US 2014/0157523 A1
(43) Pub. Date: Jun. 12, 2014

(54) MULTIFUNCTIONAL MANUAL TOOL

(71) Applicant: DAB PUMPS S.P.A., MESTRINO (IT)

(72) Inventors: Stefano Tazioli, Rosignano Marittimo (IT); Francesco Sinico, Montecchio Maggiore (IT)

(73) Assignee: DAB PUMPS S.P.A., MESTRINO (IT)

(21) Appl. No.: 14/102,927

(22) Filed: Dec. 11, 2013

(30) Foreign Application Priority Data
Dec. 12, 2012 (IT) PD2012U000098

(51) Int. Cl. B25F 1/02

(52) U.S. Cl. CPC B25F 1/02
USPC 7/138

(57) ABSTRACT

A multifunctional manual tool, of the type comprising a plurality of portions of keys of tools, the tool comprising a first element and a second element, each of which supports the portions of keys, the elements having an elongated shape to be associated transversely with each other so as to form at least one possible cross-shaped configuration for use for the tool, the first element having, between its two end portions, at least one slot designed to be crossed by the second element during their assembly.

The present invention relates to a multifunctional manual tool.

### BACKGROUND OF THE INVENTION

The use of connecting elements such as screws, bolts and the like, to be tightened and loosened by means of adapted manual tools, such as screwdrivers or keys (of the open-jawed type, ring type, socket head type, etc.), or electric tools that support tips shaped complementarily to the head of the coupling (such as slot tips, cross-recess tips, etc.), is presently particularly widespread.

Very often, some devices have multiple parts that are mutually connected by means of a plurality of different connecting elements, such as screws or threaded plugs or other similar elements, which have for this purpose polygonal portions or notches so as to be manipulated by means of manual tools such as screwdrivers or keys.

The assembly or disassembly of these devices therefore requires the use of a corresponding number of tools of different types and sizes that the user does not always have.

### SUMMARY OF THE INVENTION

The aim of the present invention is to provide a multifunctional manual tool provided with a plurality of keys of tools that are indispensable for the assembly and disassembly of a specific device.

Within this aim, an object of the invention is to propose a tool that is structurally simple and easy to use.

Another object of the invention is to propose a tool that can be manufactured with known technologies.

This aim, as well as these and other objects that will become more apparent hereinafter, are achieved by a multifunctional manual tool, of the type comprising a plurality of portions of keys of tools, characterized in that it comprises a first element and a second element, each of which supports said portions of keys, said elements having an elongated shape in order to be associated transversely with each other so as to form at least one possible cross-shaped configuration for use for said tool, said first element having, between its two end portions, at least one slot designed to be crossed by said second element during their assembly.

### BRIEF DESCRIPTION OF THE DRAWINGS

Further characteristics and advantages of the invention will become more apparent from the detailed description of a tool according to the invention, illustrated by way of non-limiting example in the accompanying drawings, wherein:

FIG. 1 is a perspective view of the tool according to the invention in a first configuration for use;

FIG. 2 is a perspective view of the tool according to the invention in a second configuration for use;

FIG. 3 is another perspective view of the tool according to the invention in an inactive initial configuration;

FIG. 4 is an exploded perspective view of the tool according to the invention in the inactive initial configuration.

### DESCRIPTION OF THE PREFERRED EMBODIMENTS

With reference to the figures, the tool according to the invention, generally designated by the reference numeral 10, is of the type that comprises a plurality of portions of keys 11 of tools. In particular, as shown clearly, it comprises a first element 12 and a second element 13, each of which supports the portions of keys 11 and has an elongated shape so that they can be associated transversely with each other so as to form two possible cross-shaped configurations of use, A and B, for the tool 10.

More particularly, the first element 12 has, between its two end portions 14, two slots 15 that are preset selectively to be crossed by the second element 13 during assembly, while at said two end portions 14 it has respectively a cap key 16, preferably a hexagonal one as in the illustrated case, and a coupling portion 17 that extends in a fork-like shape, with two dovetail tabs 18 so as to form a self-centering tapered opening for the accommodation of a flat portion of parts to be disengaged. Moreover, the tabs 18 also each have a grip tooth 19 for retaining between them the flat portion, penetrating with said teeth an adapted opening of the latter.

The shape of the two tabs 18 is visible more clearly in the view of FIG. 4. Such tabs, moreover, are provided on staggered planes and between two opposite and parallel shoulders 20 for preventing an excessive spacing of the tabs, which facilitate the grip of the user of the elements, for example when the element must be extracted from an adapted receptacle from which it can protrude with said end portion 14.

Moreover, each one of the shoulders 20 has, on the side opposite to the tabs 18, a ridge 21 that forms, with two ends of the same shoulder 20, three resting and guiding points for the coupling portion 17 in an adapted circular seat in which the flat portion of the part to be disengaged is located.

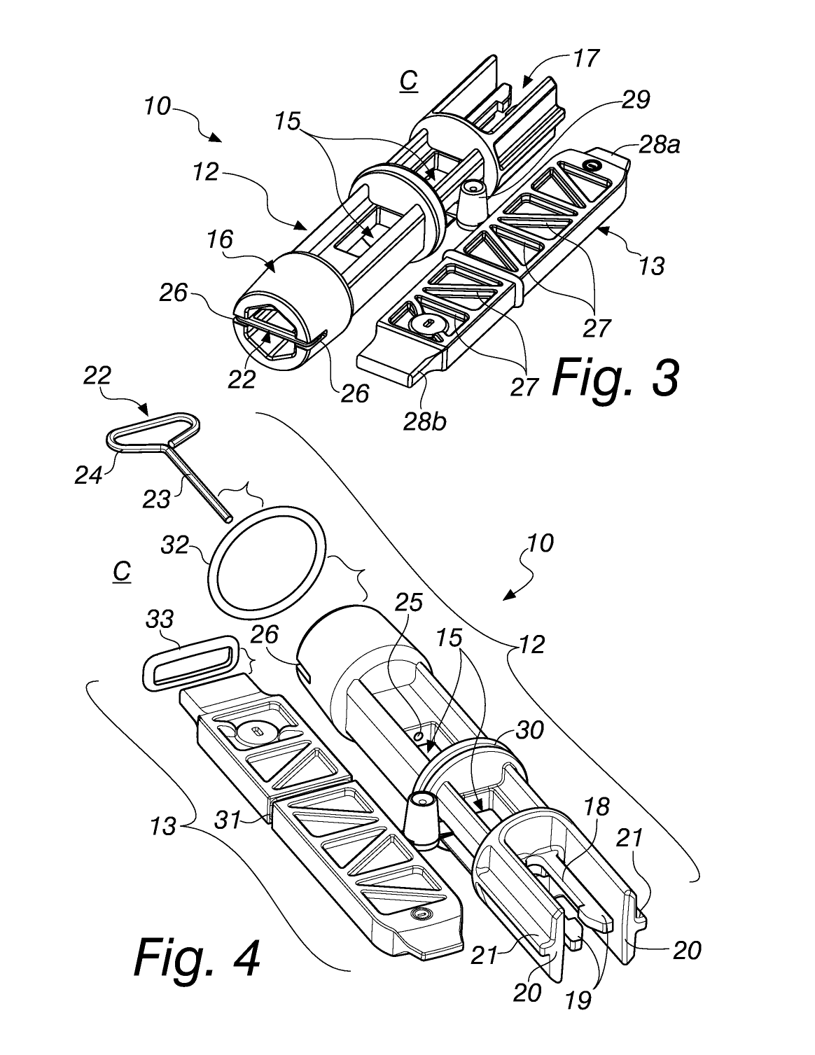

Moreover, the first element 12 is provided also with a socket head key 22 (shown in FIGS. 3 and 4), which has an axial portion 23 and a grip portion 24 that are substantially annular, as shown in the exploded view of FIG. 4.

The socket head key 22 is accommodated axially in the cap key 16, which conveniently has an axial hole 25 that accommodates its axial portion 23 and two guides 26 formed by two diametrically opposite slots in which the annular grip portion 24 is inserted by sliding. The receptacle is clearly visible in FIG. 3 and is constituted substantially by the opening of the cap key 16, and the slots in which the grip portion 24 slides are likewise clearly visible. FIG. 4 instead shows and designates the axial hole 25 in which the axial portion 23 of the cap key 22 is inserted.

The second element 13, on the other hand, has a substantially flat shape, with stiffening ridges 27 and a tapering of its cross-section at each one of its two end portions 28a and 28b, which are shaped like slot screwdriver tips with mutually different dimensions. In particular, the end designated by the reference numeral 28a is smaller than the end 28b, being preset to open fixing elements with slots of different sizes.

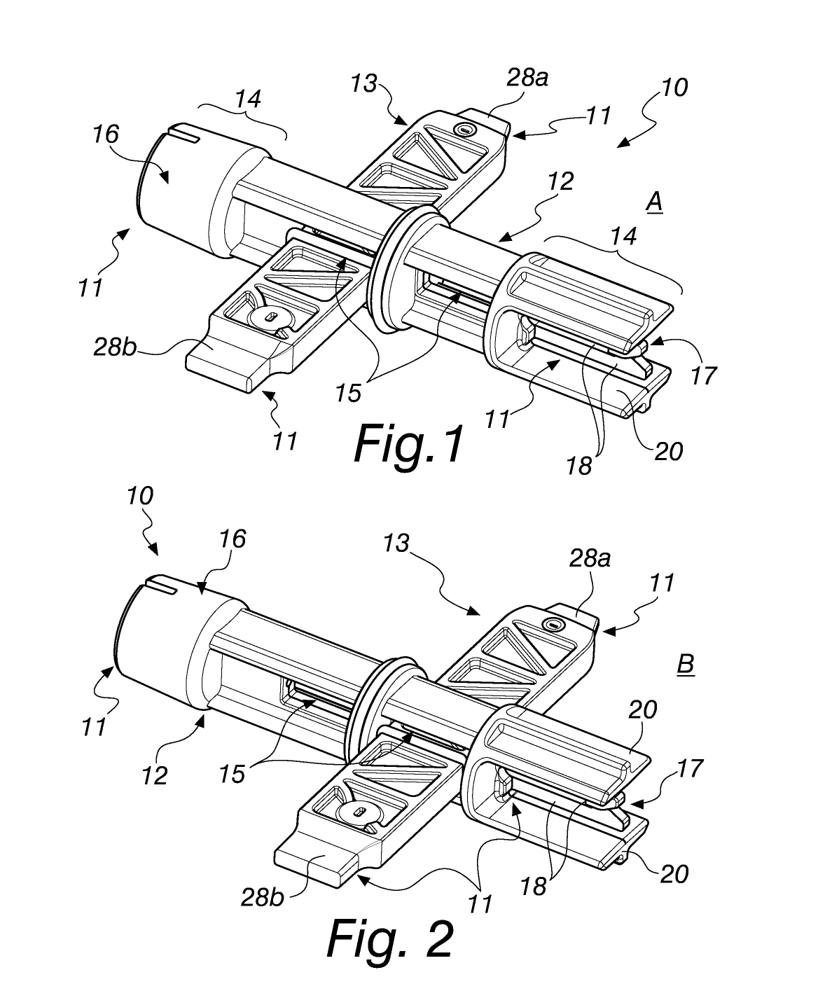

By observing the two slots 15 of the first element 12 and in particular in FIGS. 1 and 2 it is possible to note that one of said slots is advantageously closer to the cap key 16 for association with the second element 13 in a first configuration A for use of the coupling portion 17, as shown in the first of the two figures. The other one of the two slots 15 instead is advantageously closer to the engagement portion 17 for association with the second element 13 in a second configuration B for use of the cap key 16, as shown in FIG. 2.

FIG. 3 instead shows the tool 10 in a configuration that precedes its first use, i.e., the initial inactive configuration C.

The first element 12 and the second element 13 are in fact provided monolithically by molding plastic material, and, as can be seen clearly from the above-cited figure and from the following one, as a consequence of molding the two elements are joined in the initial inactive configuration C by a connection 29 that is preset for breakage in order to assemble the tool 10 in one of the configurations for use, the first one A or the second one B.

In FIG. 4 it is possible to note a first groove 30 and a second groove 31 in the intermediate regions respectively of the first element 12 and of the second element 13, in which respectively a first U-ring 32 and a second O-ring 33, having shapes and dimensions that are appropriate for the respective element, are positioned.

The portions of keys 11 can be selected and modified appropriately as a function of the fixing elements of the device and the tool 10 can be provided advantageously to the user together with the device itself and can be optionally inserted in an adapted receptacle thereof, inside which it is locked and free from any vibrations thanks to the two O-rings 32 and 33.

The use of the tool according to the invention is as follows.

Initially, the two elements, the first one 12 and the second one 13, are separated by breaking manually the connection 29. Then, in order to pick up parts that have flat portions that protrude from the walls of the device, the tool is assembled according to the first configuration A: the second element 13 is associated transversely with respect to the first one, by being inserted through the slot 15 of the two slots that is closer to the cap key 16. In this manner, the first element 12 is divided into two parts by the second element 13 and the part that supports the coupling portion 17 is longer than the other one so that the flat portion of the part to be disengaged can be reached easily; moreover, grip is facilitated, leaving more free space for the hand, which grips the tool by wrapping the fingers around the second element.

To unscrew elements with a polygonal head, or in this specific case a hexagonal head, the socket head key 22 must be extracted from the cap key 16 and the tool 10 is assembled in the second configuration B: the second element 13 is inserted in the slot 15 that is closest to the coupling portion 17 and in this manner grip is facilitated for this purpose.

The two ends 28a and 28b of the second element 13 instead can be used easily to unscrew or screw fixing elements that have a slot that is shaped complementary thereto, both when the tool 10 is assembled according to the first configuration A and when it is assembled in the second configuration B.

The socket head key 22 can instead be used independently of the other portions of keys 11; in fact it can be extracted easily from the cap key 16 and stored therein simply by making the axial portion 23 slide in the axial hole 25 and by making the annular grip portion 24 slide in the adapted guides 26.

In practice it has been found that the invention achieves the intended aim and objects, providing a manual tool that lends itself to be used for multiple types of fixing elements by being provided with a plurality of keys of tools that are selected preferably specifically for the assembly and disassembly of a specific device.

Moreover, the tool is easy to use thanks to the cross-like shape and the possibility of assembling it according to two possible configurations as a function of the requirements.

Moreover, the tool is structurally simple and can be manufactured with known technologies for the molding of plastic material.

In practice, the materials used, as well as the dimensions, may be any according to the requirements and the state of the art.

The disclosures in Italian Utility Model Application No. PD2012U000098 from which this application claims priority are incorporated herein by reference.

What is claimed is:

1. A multifunctional manual tool, of the type comprising a plurality of portions of keys of tools, further comprising a first element and a second element, each of which supports said portions of keys, said elements having an elongated shape to be associated transversely with each other so as to form at least one possible cross-shaped configuration for use for said tool, said first element having, between its two end portions, at least one slot designed to be crossed by said second element during their assembly.

2. The tool according to claim 1, wherein said first element has, at its two end portions, respectively a cap key and a coupling portion that extend in a fork-like manner, with two tabs that end in a dovetail shape so as to form a self-centering tapered opening for the accommodation of a flat portion of parts to be disengaged, said tabs also being provided with a grip tooth each for the retention of said flat portion between them.

3. The tool according to claim 2, wherein said first element is provided with a socket head key that has an axial portion and a grip portion that is substantially annular and is accommodated axially in said cap key, which has an axial hole that accommodates said axial portion thereof and two guides that are formed by two diametrically opposite slots in which said annular grip portion is inserted by sliding.

4. The tool according to claim 1, wherein each of the two ends of said second element is shaped like the tip of a slot screwdriver, with mutually different dimensions.

5. The tool according to claim 4, wherein said second element has a substantially flat shape, with a tapering of the cross-section at each of its ends that are shaped like a slot screwdriver.

6. The tool according to claim 2, wherein said first element has two of said slots, one closer to said cap key for association with said second element in a first configuration for use of said coupling portion, the other one closer to said engagement portion for association with said second element in a second configuration for use of said cap key.

7. The tool according to claim 1, wherein said first element and said second element are provided monolithically by molding plastic material, by which they are joined, in an initial inactive configuration, by a connection that is preset to break for the assembly of said tool in said at least one possible active configuration for use.
